(19) United States
(12) Patent Application Publication
(10) Pub. No.: US 2026/0195083 A1
(43) Pub. Date: Jul. 9, 2026

(54) NON-TRANSITORY COMPUTER READABLE STORAGE MEDIUM

(71) Applicant: BROTHER KOGYO KABUSHIKI KAISHA, Nagoya (JP)

(72) Inventors: Airi EGUCHI, Ichinomiya (JP); Yoshito HOSOMIZO, Konan (JP); Kenju NARITA, Nagoya (JP)

(21) Appl. No.: 19/556,657

(22) Filed: Mar. 4, 2026

Related U.S. Application Data
(63) Continuation-in-part of application No. PCT/JP2024/039786, filed on Nov. 8, 2024.

(30) Foreign Application Priority Data
Dec. 15, 2023 (JP) 2023-212237

(51) Int. Cl. G06F 3/12

(52) U.S. Cl. CPC G06F 3/1234; G06F 3/121; G06F 3/1257; G06F 3/1267

(57) ABSTRACT

A non-transitory computer readable storage medium storing a support program. The support program causes a computer to execute: a storing process of storing print data; and a print process of causing a printer to perform printing according to the print data and a print setting. A general-purpose printing program is configured to output an error event in response to receiving an error notification from the printer. The support program further includes: a receiving process of receiving re-execution of the printing; and in a case where the re-execution is received in the receiving process, a reprint process of causing the printer to perform the printing based on the print data and the print setting which are stored in a memory.

### REFERENCE TO RELATED APPLICATIONS

This is a continuation in part application of International Application No. PCT/JP2024/039786 filed on November 8, 2024, which claims priority from Japanese Patent Application No. 2023-212237 filed on December 15, 2023. The entire contents of the aforementioned applications are incorporated herein by reference.

### BACKGROUND ART

In a related art, a technique is known in which, after print data is transmitted from an information processing device to a printer, the print data is retransmitted when an error occurs in the printer. For example, the related art discloses a configuration in which a personal computer (PC) has a printer driver installed, and the printer driver generates print data, temporarily stores the print data and transmits the print data to a printer, then receives results of processing the print data by the printer, changes print settings according to the received processing results, regenerates the print data, and transmits the regenerated print data to the printer.

In recent years, a technique has been put into practical use in which a printer is controlled by an OS-standard general-purpose printing program that is part of the operating system (OS), without using a printer driver provided by a printer vendor. With this technique, when the OS detects a printer, association with the OS-standard general-purpose printing program is performed, and thereafter, when a print instruction for the printer is received, the OS-standard general-purpose printing program generates print data without using the printer driver provided by the printer vendor, making it possible to print using the OS-standard general-purpose printing program.

However, unlike the printer driver provided by the printer vendor, the OS-standard general-purpose printing program does not have a function of retransmitting print data when an error occurs in a printer, as disclosed in the related art. Therefore, if an error occurs in a printer after a user issues a print instruction using an application program, the user needs to issue the print instruction using the application program again after resolving the error.

### SUMMARY

A non-transitory computer readable storage medium storing a support program for solving the above-described problems, the support program is executable by a computer of an information processing device and corresponding to a printer connected to the information processing device. The information processing device is mounted with an operating system having a general-purpose printing program. The support program causes the computer to execute: when a print instruction that is output from an application program incorporated in the information processing device and that instructs the general-purpose printing program to cause the printer to print an image is received, a storing process of storing print data indicating the image to be printed by the print instruction and a print setting corresponding to the print instruction in a memory of the information processing device; and a print process of causing the printer to perform printing according to the print data and the print setting. The general-purpose printing program is configured to output an error event in response to receiving an error notification from the printer that has received the print data. The support program causes the computer to further execute: in a case where the error event is output from the general-purpose printing program and a predetermined condition is satisfied, a receiving process of receiving re-execution of the printing; and in a case where the re-execution is received in the receiving process, a reprint process of causing the printer to perform the printing based on the print data and the print setting which are stored in the memory.

### BRIEF DESCRIPTION OF THE DRAWINGS

FIG. 1 is a block diagram showing an outline of an electrical configuration of a PC.

FIG. 2 is a sequence diagram showing an example of a printing execution procedure.

FIG. 3 is a sequence diagram showing an example of an error handling procedure.

FIG. 4 is a diagram illustrating an example of a sheet jam handling screen.

FIG. 5 is a diagram illustrating an example of an ink replacement handling screen.

FIG. 6 is a diagram illustrating an example of a sheet size mismatch handling screen.

FIG. 7 is a sequence diagram showing an example of a setting change procedure.

### DESCRIPTION

Hereinafter, a personal computer (hereinafter, referred to as a "PC") that uses a support program according to an embodiment will be described in detail with reference to the accompanying drawings. The present specification discloses a support program that runs on the PC.

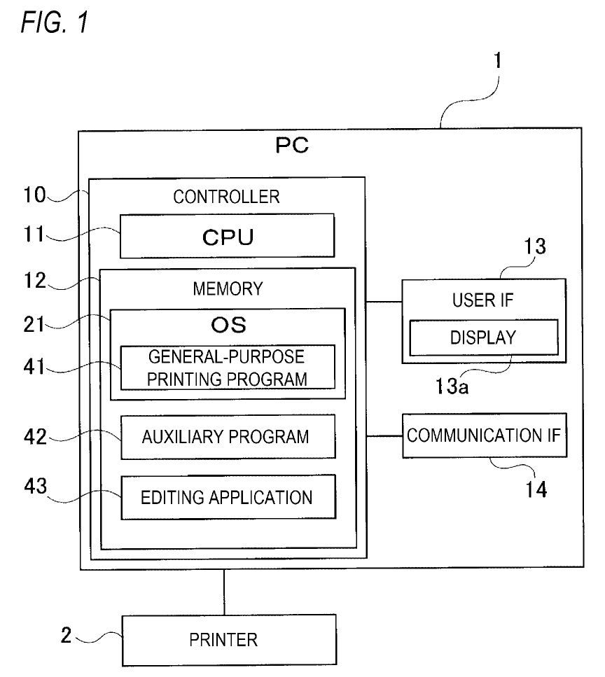

As illustrated in FIG. 1, a PC 1 according to the present embodiment includes a controller 10 including a CPU 11 and a memory 12. The PC 1 is an example of the information processing device. The CPU 11 is an example of the computer. The PC 1 includes a user interface (hereinafter, referred to as a "user IF") 13, and a communication interface (hereinafter, referred to as a "communication IF") 14 that are electrically connected to the controller 10. The controller 10 in FIG. 1 is a collective term for hardware and software used to control the PC 1, and does not necessarily represent a single piece of hardware actually present in the PC 1.

The CPU 11 of the PC 1 is configured to execute various types of processes, in accordance with a program read from the memory 12 and based on a user operation. The memory 12 stores various programs and various data. The memory 12 is used as a work area in a case where various types of processes are executed. A buffer provided in the CPU 11 is also an example of the memory. An example of the memory 12 is not limited to a ROM, a RAM, a HDD, and the like built into the PC 1, but may also be a storage medium that can be read and written by the CPU 11, for example, a recording medium such as a CD-ROM, a DVD-ROM, or a USB memory.

The user IF 13 includes a display 13a which is hardware that displays a screen for reporting information to a user, and hardware that receives an operation from the user. The user IF 13 may be a combination of the display 13a capable of displaying information and a mouse, a keyboard, or the like having an input receiving function, or may be a touch panel having the functions of the display 13a and the input receiving function.

The communication IF 14 includes hardware for communicating with an external device such as a printer 2. Communication standards of the communication IF 14 include Ethernet (registered trademark), Wi-Fi (registered trademark), USB, and the like. The PC 1 may be connectable to the Internet via the communication IF 14. The PC 1 may include a plurality of communication IFs 14 corresponding to a plurality of communication standards.

As shown in FIG. 1, the memory 12 of the PC 1 stores various programs and various data including an operating system (hereinafter, referred to as "OS") 21 including a general-purpose printing program 41, an auxiliary program 42, and an editing application 43. The auxiliary program 42 is an example of the support program. The editing application 43 is an example of the application program.

The OS 21 is a multitasking OS that can process a plurality of tasks in parallel by managing and switching between the plurality of tasks. The OS 21 is, for example, Windows (registered trademark), macOS (registered trademark), Linux (registered trademark), iOS (registered trademark), or Android (registered trademark).

The OS 21 includes the general-purpose printing program 41. The general-purpose printing program 41 is an OS-standard program prepared by a vendor of the OS 21 and provided as a part of the OS 21. That is, the PC 1 is equipped with the OS 21 having the general-purpose printing program 41. The general-purpose printing program 41 is not configured to use a printer driver specific to each printer.

The general-purpose printing program 41 is a program having a function of causing printers of a plurality of types of models respectively provided by a plurality of vendors to execute printing based on an instruction of a user. The general-purpose printing program 41 supports a general-purpose function that enable printing to be performed on many printers. Unlike a printer driver specific to each printer, the general-purpose printing program 41 does not support functions specific to each printer or printer driver, in particular, functions that require complex processes.

The general-purpose printing program 41 is a program that includes a function of receiving image data designated as a printing target by a print instruction output from various applications based on an instruction of a user, and generating intermediate data based on the image data. The intermediate data is, for example, XPS data. The general-purpose printing program 41 further has a function of generating raster data in a format that can be used for printing on various printers, based on the intermediate data. The raster data is, for example, PWG Raster data. The general-purpose printing program 41 has a function of transmitting the generated raster data to a printer designated as a device to execute printing, via a communication function of the OS 21. The general-purpose printing program 41 can also transmit PDF data to a printer to cause the printer to print the PDF data.

The auxiliary program 42 is a program or a group of programs that executes processes based on an instruction from the OS 21 in conjunction with the process of the general-purpose printing program 41, and is a program that supports the control of target hardware. The auxiliary program 42 of the present embodiment corresponds to a model of the printer 2 connected to the PC 1, and is provided by, for example, the vendor of the printer 2. The general-purpose printing program 41 activates the auxiliary program 42 compatible with the printer 2 when the printer 2 is selected as a device for executing printing, when an instruction for detailed print settings is received in a state where the printer 2 is selected, when an instruction for causing the printer 2 to execute printing is received, or the like. The auxiliary program 42 is called, for example, a print support application (abbreviated as PSA) or a hardware support application (abbreviated as HSA).

The auxiliary program 42 may be a combination of a plurality of programs each of which receives an execution command, or may be one single program that can execute different processes in response to commands. Further, the auxiliary program may be a program prepared for each type of printer by the vendor of the printer. For example, an auxiliary program for an inkjet printer and an auxiliary program for a laser printer may be prepared separately. The auxiliary program may be prepared not only for each type of printer, but also for each model of printer or each series of printer models.

For example, when a new printer is connected to the PC 1, the OS 21 of the PC 1 can download an appropriate auxiliary program from a server or the like of the vendor of the printer according to the type or model of the connected printer and incorporate the auxiliary program into the PC 1. The OS 21 stores identification information of the incorporated auxiliary program in the memory 12 in association with printer information of the newly connected printer.

The editing application 43 is, for example, a program for creating and editing image data and document data. The editing application 43 may be, for example, Microsoft Word (registered trademark) or PowerPoint (registered trademark) manufactured by Microsoft (registered trademark), or may be a program provided by the vendor of the printer 2. The editing application 43 can receive, via the user IF 13, an instruction to cause the printer 2 to execute printing, for example. The editing application 43 is not limited to a program for creating or editing data, and may be a program that has a function of receiving a display instruction or a print instruction for various kinds of information such as map information or a web page in response to user requests.

The PC 1 of the present embodiment is connected to the printer 2 via the communication IF 14 as shown in FIG. 1. The printer 2 is a device that has at least a printing function and a communication function. For example, when receiving print data from the PC 1 or the like, the printer 2 can execute printing based on the received print data. The printer 2 may be a device capable of color printing, or may be a device capable of only monochrome printing.

Next, a process procedure for causing the printer 2 to print in the PC 1 having the general-purpose printing program 41 will be described. Each process in the present embodiment basically indicates a process of the CPU 11 according to instructions written in a program such as the auxiliary program 42. The process executed by the CPU 11 also includes control of hardware using API of the OS 21. In the present specification, a detail description of the OS 21 is omitted, and an operation of each program is described. The term "acquisition" is used as a concept indicating that a request is not essential.

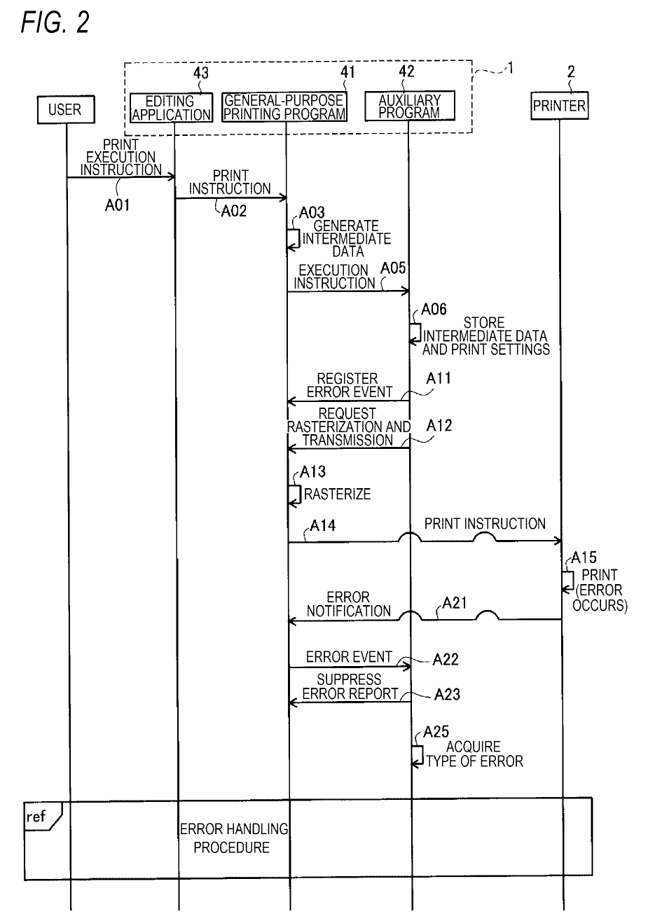

A printing execution procedure will be described with reference to the sequence diagram of FIG. 2. After determining an image to be printed and print settings, a user inputs an instruction for print execution into the editing application 43 (A01). When the OS 21 includes the general-purpose printing program 41, the editing application 43 can receive an instruction for print execution from the general-purpose printing program 41 to cause the printer 2 to print the selected image.

The editing application 43 outputs a print instruction to the general-purpose printing program 41 based on the received user operation (A02). The general-purpose printing program 41 acquires, from the editing application 43, image data indicating an image to be printed and information indicating print settings as information on the print instruction output from the editing application 43.

The general-purpose printing program 41 generates intermediate data by converting the format of the image data of the image to be printed into the format of the intermediate data based on the information acquired from the editing application 43 (A03). The image data included in the editing application 43 is of various types, and the general-purpose printing program 41 converts the image data to be printed into intermediate data suitable for generating raster data. When the image data to be printed is data suitable for generation of the raster data, generation of intermediate data may be omitted and the image data may be used as intermediate data as it is.

It is noted that the general-purpose printing program 41 may be capable of receiving an instruction for print settings by a user operation before generating the intermediate data. Further, before generating the intermediate data, the general-purpose printing program 41 may activate the auxiliary program 42 corresponding to the printer 2 and notify that the process of a print job corresponding to the print instruction output from the editing application 43 has been started.

Further, the general-purpose printing program 41 may be capable of receiving an instruction from the user who performs detailed print settings, and activating the auxiliary program 42 when receiving the instruction for the detailed print settings. When the auxiliary program 42 is activated from the general-purpose printing program 41, the auxiliary program 42 can receive an instruction for the print settings by a user operation and pass the received pieces of information to the general-purpose printing program 41.

After generating the intermediate data, the general-purpose printing program 41 activates the auxiliary program 42 corresponding to the printer 2, passes the instruction for print execution, and requests processing (A05). The auxiliary program 42 can acquire the intermediate data and information on the print settings related to the current job by making a request to the general-purpose printing program 41. The auxiliary program 42 stores the intermediate data and the information on the print settings acquired from the general-purpose printing program 41 in the memory 12 (A06). A06 is an example of the storing process. The intermediate data is an example of the print data indicating an image to be printed.

When the auxiliary program 42 is activated from the general-purpose printing program 41 and receives an instruction for print settings or an instruction for print execution, the auxiliary program 42 may acquire capability information of the printer 2. The auxiliary program 42 may, for example, request the general-purpose printing program 41 to acquire the capability information, and acquire the capability information from the printer 2 via the general-purpose printing program 41. It is noted that the general-purpose printing program 41 performs communication with the printer 2 via the OS 21, for example, by communication according to internet printing protocol (IPP). Instead of making a request to the general-purpose printing program 41, the auxiliary program 42 may acquire the capability information directly from the printer 2 using, for example, a management information base (MIB).

The capability information acquired from the printer 2 may include, for example, information on parameters that can be set as print settings, information on the remaining amount of consumables, information on selectable trays, sheet information on sheet set in each tray, and information on compatible print resolutions. The printer 2 may also pass capability information including information indicating its own status.

The auxiliary program 42 registers an error event in the general-purpose printing program 41 regarding the current print job (A11). If an error event is registered, the general-purpose printing program 41 activates the auxiliary program 42 and passes information on the error to the auxiliary program 42 in a case where an error notification informing the error is received from the printer 2 that executes printing.

The error event may be registered at any time after the auxiliary program 42 is activated based on the print instruction and before the print data is transmitted to the printer 2. The auxiliary program 42 may register an error event each time a print instruction is issued, or if the general-purpose printing program 41 has a function of maintaining information on error event registration, A11 may be omitted if registration has already been performed. Further, if the general-purpose printing program 41 is configured to output an error event to the auxiliary program 42 when the error notification is received, regardless of whether the error event is registered, A11 is not necessary.

The auxiliary program 42 instructs the general-purpose printing program 41 to rasterize the intermediate data and to transmit raster data, which is data after the rasterization (A12). A12 is a process for causing the printer 2 to perform printing based on the print data and the print settings, and is an example of the print process. It is noted that the auxiliary program 42 may adjust the intermediate data or the print settings as necessary, and in that case, the adjusted data may be passed to the general-purpose printing program 41 in A12.

The general-purpose printing program 41 rasterizes the intermediate data to generate raster data (A13), and transmits the generated raster data to the printer 2 (A14). The printer 2 starts printing based on the received raster data (A15).

The auxiliary program 42 may perform the rasterization instead of the general-purpose printing program 41. In this case, the auxiliary program 42 executes rasterization based on the intermediate data to generate raster data, passes the generated raster data and the print settings to the general-purpose printing program 41, and instructs the general-purpose printing program 41 to transmit the raster data and the print settings to the printer 2. The raster data transmitted to the printer 2 may be in any format that can be printed by the printer 2.

When rasterization is performed by the auxiliary program 42, the degree of freedom is higher as compared with the case where rasterization is performed by the general-purpose printing program 41, and raster data suitable for printing by the printer 2 is more likely to be generated. On the other hand, when the rasterization is performed by the general-purpose printing program 41, the number of processes of the auxiliary program 42 is reduced, and the program size of the auxiliary program 42 can be reduced.

Further, instead of transmitting the raster data from the general-purpose printing program 41 to the printer 2, the auxiliary program 42 may transmit the raster data and a print command instructing execution of printing to the printer 2. For example, if the print settings include a setting related to image processing that can be performed by the printer 2, the auxiliary program 42 may generate a print command including information on the processing.

The printer 2 notifies the general-purpose printing program 41 of a print result of the received print job. When the printing is completed, the printer 2 notifies the general-purpose printing program 41 of the completion of the printing. In this case, the general-purpose printing program 41 does not output an error event, but notifies the editing application 43 of the end of the job, and ends the process. When the printing is completed, the printer 2 may not notify the general-purpose printing program 41 of the completion of the printing. In this case, the general-purpose printing program 41 operates on the assumption that the printing is completed based on the completion of the transmission of the generated raster data to the printer 2.

On the other hand, after transmitting the generated raster data to the printer 2 in A14, the general-purpose printing program 41 monitors whether an error has occurred during the print process in the printer 2. In a case where an error occurs during the print process in the printer 2, the printer 2 transmits an error notification including information on the error that occurred to the general-purpose printing program 41 that is in monitoring (A21). The error notification transmitted from the printer 2 may include information indicating the type of error. The types of error include, for example, cover open, no coloring material, extremely small amount of coloring material, small amount of coloring material, no sheet, small amount of sheet, sheet jam, no empty space in sheet discharging tray, little empty space in sheet discharging tray, sheet size mismatch, or the like. When receiving an error notification from the printer 2 in a state where an error event has been registered, the general-purpose printing program 41 activates the auxiliary program 42 and outputs the error event (A22).

When the auxiliary program 42 receives the error event, the auxiliary program 42 passes, to the general-purpose printing program 41, a suppression instruction to set the general-purpose printing program 41 to not report an error (A23). A23 is an example of the setting process. When the general-purpose printing program 41 does not receive the instruction to not report an error, the general-purpose printing program 41 reports the error by itself in response to the reception of the error notification. Once receiving the suppression instruction in A23, the general-purpose printing program 41 does not report the error based on the error notification. Accordingly, it is possible to prevent the general-purpose printing program 41 and the auxiliary program 42 from redundantly reporting the error.

The auxiliary program 42 acquires information indicating the type of error that has occurred (A25). A25 is an example of the acquisition process. When the general-purpose printing program 41 outputs an error event including information on the type of error included in the error notification, the auxiliary program 42 can acquire information indicating the type of error based on the error event. When an error event that does not include information on the type of error is received from the general-purpose printing program 41, the auxiliary program 42 may, for example, acquire information on the type of error that was included in the error notification by making a request to the general-purpose printing program 41. Further, for example, when the error notification transmitted from the printer 2 does not include the information indicating the type of error, the auxiliary program 42 may request and acquire the information indicating the type of error from the printer 2.

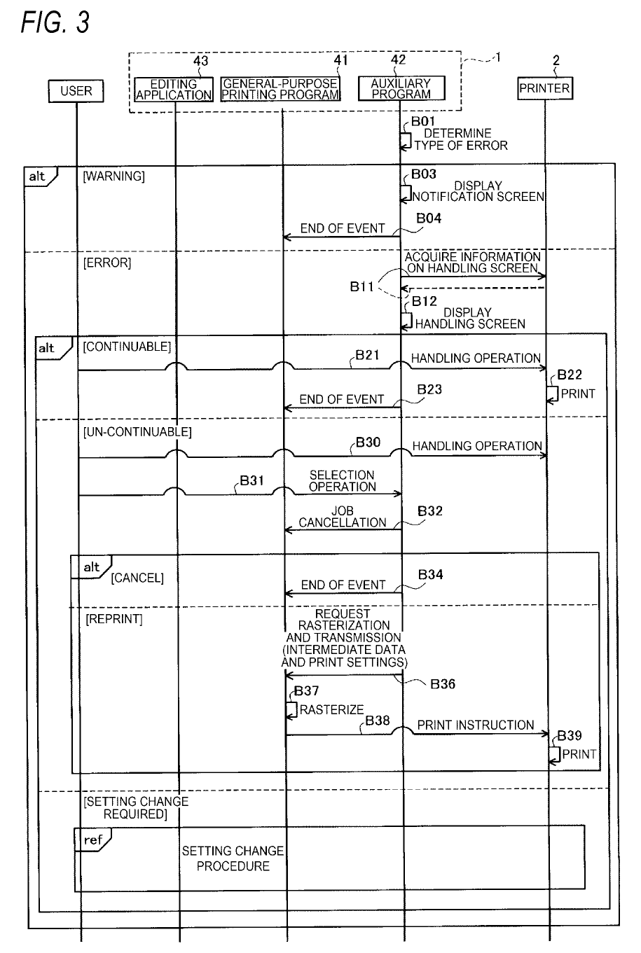

Then, an error handling procedure will be described with reference to the sequence diagram of FIG. 3. The auxiliary program 42 determines whether the type of error is a warning or an error based on the information indicating the type of error acquired in A25 of FIG. 2 (B01). An error notification indicating a warning is a notification indicating that printing of the current job is completed, but an error may occur at the time of the next printing. An error notification indicating an error is a notification indicating that printing of the current job has not been completed.

If it is determined that the type of error indicated in the received error notification is a warning (alt: [warning]), the auxiliary program 42 causes the user IF 13 to display a notification screen for reporting the type of error (B03). The types of error that indicate a warning include, for example, extremely small amount of coloring material, small amount of coloring material, small amount of sheet, and little empty space in sheet discharging tray. The auxiliary program 42 displays the notification screen for a predetermined time, for example, and then notifies the general-purpose printing program 41 of the end of the event (B04). As a result, the general-purpose printing program 41 and the auxiliary program 42 end the process of the current job.

If it is determined that the type of error indicated in the received error notification is not a warning but an error (alt: [error]), the auxiliary program 42 requests the printer 2 to acquire screen data for a handling screen corresponding to the type of error (B11). Then, the auxiliary program 42 causes the user IF 13 to display the handling screen based on the acquired screen data (B12). B12 is an example of the error report process. The handling screen is an example of the error report screen. The handling screen is a screen for reporting to the user on a message indicating the type of error that has occurred and information indicating a handling method.

The auxiliary program 42 reports the type of error and a handling method of handling the error for each type of error. Therefore, the user can grasp that an error has occurred in the printer 2 and the handling method for the error. This will enable the user to handle the error.

The printer 2 has screen data for various handling screens according to its own model and the type of error. The screen data acquired from the printer 2 may be data indicating the same screen as the screen displayed on an operation panel of the printer 2. By acquiring the screen data from the printer 2, the auxiliary program 42 can display a handling screen including a detailed message suitable for the model of the printer 2. The screen data for the handling screen may be included in the auxiliary program 42 from the time of installation, or may be stored in an external device such as a server managed by a printer vendor. If the screen data is stored in the server, the auxiliary program 42 transmits, for example, the model information of the printer 2 and the information on the type of error to the server, and acquires the screen data of the corresponding handling screen from the server.

The types of error are further classified into a continuable error, an un-continuable error, and a setting change required error. The continuable error is an error that allows the printer 2 to continue printing after the error is resolved by the user taking appropriate action on the printer 2. The continuable error is an example of a first type of error. The un-continuable error and the setting change required error are errors that prevent the printer 2 from continuing printing after the error is resolved by the user on the printer 2, and require the raster data to be transmitted again in order to complete the printing. The un-continuable error and the setting change required error are examples of the second type of error. The un-continuable error is an error where printing is likely to be completed by retransmitting the same raster data, while the setting change required error is an error where printing is likely to be completed by changing the print settings and regenerating the raster data. The setting change required error is an example of the third type error among the second type of errors.

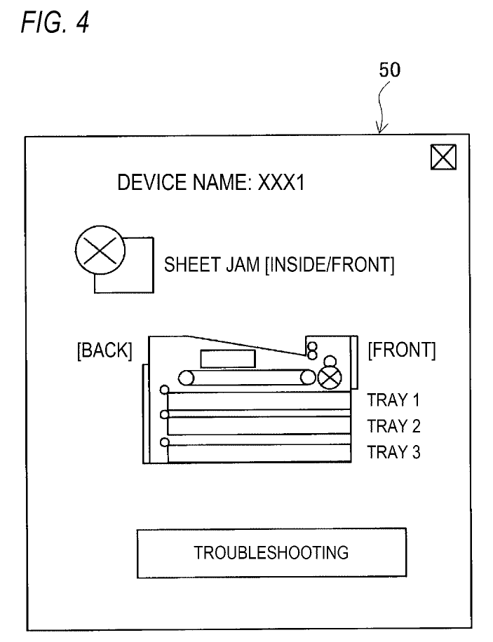

The continuable error is, for example, no sheet, sheet jam, or cover open. In the case of a continuable error, the auxiliary program 42 displays a handling screen showing a handling method. When the error is sheet jam, in B12, the auxiliary program 42 displays a sheet jam handling screen 50 including, for example, a message indicating that sheet jam has occurred and a diagram indicating the location of the jam as illustrated in FIG. 4.

If it is determined that the error is a continuable error (alt: [continuable]), the auxiliary program 42 displays a handling screen in B12 and waits for the user to take action. When the user takes a handling action, such as removing the jammed sheet, based on the displayed handling screen 50 (B21), the printer 2 automatically continues printing (B22). In the case of the continuable error, there is a high possibility that the user appropriately handles the error based on the handling screen displayed by the auxiliary program 42 in B12.

The auxiliary program 42 displays the handling screen for a predetermined time, then ends the display and notifies the general-purpose printing program 41 of the end of the event (B23). The auxiliary program 42 may continue to display the handling screen until a print completion notification is received from the printer 2.

If the error that has occurred is a continuable error, the printer 2 can complete printing by receiving a solution from the user in the printer 2 without retransmitting the print data. If the error that has occurred is a continuable error, a predetermined condition is not satisfied, and therefore the auxiliary program 42 does not receive an instruction to re-execute printing. That is, when the error that has occurred is a continuable error, the auxiliary program 42 waits for the error to be resolved without receiving a selection by the user of whether to perform reprinting. Therefore, early reprinting by the printer 2 can be expected.

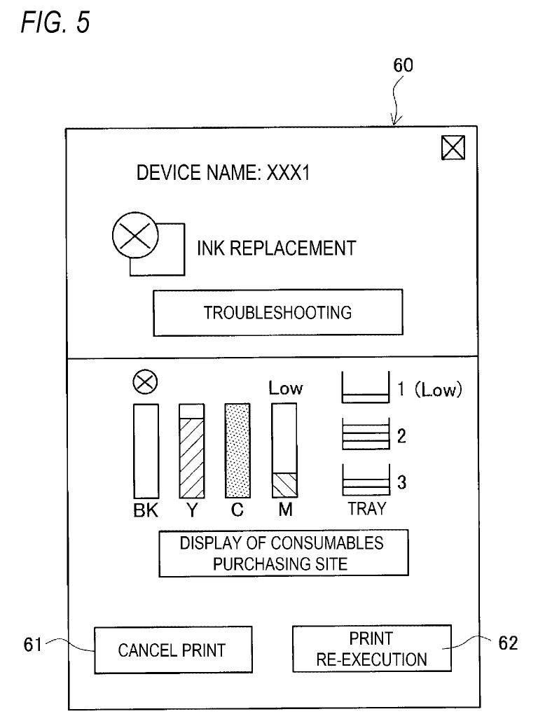

The un-continuable error is, for example, no coloring material. The printer 2 cannot continue printing without coloring material. When the coloring material is replaced, the printer 2 resets the raster data being printed. For example, when the error is no coloring material, in B12, the auxiliary program 42 displays a no coloring material handling screen 60 including a print cancel button 61 and a print re-execution button 62 as illustrated in FIG. 5. The no coloring material handling screen 60 is an example of a handling screen that can receive re-execution of printing. If the error that has occurred is an un-continuable error, the predetermined condition is satisfied, and the auxiliary program 42 displays a handling screen that can receive an instruction to re-execute printing in B12.

If it is determined that the error is an un-continuable error (alt: [un-continuable]), the auxiliary program 42 waits for the user to operate the handling screen displayed in B12. Then, when the auxiliary program 42 receives the selection as to whether to re-execute the printing by the operation of the user (B31), the auxiliary program 42 first passes an instruction to cancel the current job to the general-purpose printing program 41 (B32). This is because, regardless of which selection is accepted, the printer 2 is not able to continue printing. B31 is an example of the receiving process. The auxiliary program 42 may execute B32 before receiving the operation in B31.

When issuing an instruction to re-execute printing, the user performs a handling operation on the printer 2 before operating the handling screen (B30). For example, when the user operates the print re-execution button 62 on the no coloring material handling screen 60, the user replaces the coloring material in the printer 2 in advance. When operating the print cancel button 61, the user may not perform the handling operation of B30.

When the selection operation by the user received on the handling screen is an operation on the print cancel button 61 (alt: [cancel]), the auxiliary program 42 notifies the general-purpose printing program 41 of the end of the event (B34) and ends the process. The operation on the print cancel button 61 is an example of the print cancel instruction.

If the user does not want to reprint the print job in which the error occurred, or if it takes time to deal with the error, such as when the coloring material to be replaced is not available, the user can cancel the printing of the current job. The auxiliary program 42 can also accept cancellation of printing if the error that has occurred in the printer 2 is an un-continuable error, thereby avoiding unnecessary processes for reprinting.

On the other hand, when the selection operation by the user is an operation on the print re-execution button 62 (alt: [reprint]), the auxiliary program 42 passes the intermediate data and the print settings stored in A06 of FIG. 2 to the general-purpose printing program 41, and requests rasterization and transmission (B36). The operation on the print re-execution button 62 is an example of the print re-execution instruction.

The general-purpose printing program 41 performs rasterization in response to the request from the auxiliary program 42 to generate raster data (B37), and transmits the raster data to the printer 2 as a print instruction for a new job (B38). The printer 2 executes printing based on the newly received print instruction (B39). The process of B36 by the auxiliary program 42 is an example of the reprint process.

If the error has been resolved, the printer 2 can complete printing based on the print instruction newly received in B38. If an error occurs again in the printer 2 after the new print instruction is transmitted to the printer 2, the general-purpose printing program 41 receives an error notification as in A21 of FIG. 2. In this case, the auxiliary program 42 and the general-purpose printing program 41 execute the respective procedures in the same manner as in the first error.

Examples of the setting change required error include no empty space in sheet discharging tray and sheet size mismatch. The sheet size mismatch error is an error occurs when the sheet size set or detected for the tray designated in the print settings does not match the sheet size designated in the print settings. For example, when a tray 2 and B4 size are designated in the print settings and A4 size is set for the tray 2 in the printer 2, the sheet size mismatch error occurs. In this case, there is a possibility that the error can be resolved by changing the sheet size or the tray designated in the print settings, or by changing the sheet size set in the printer 2.

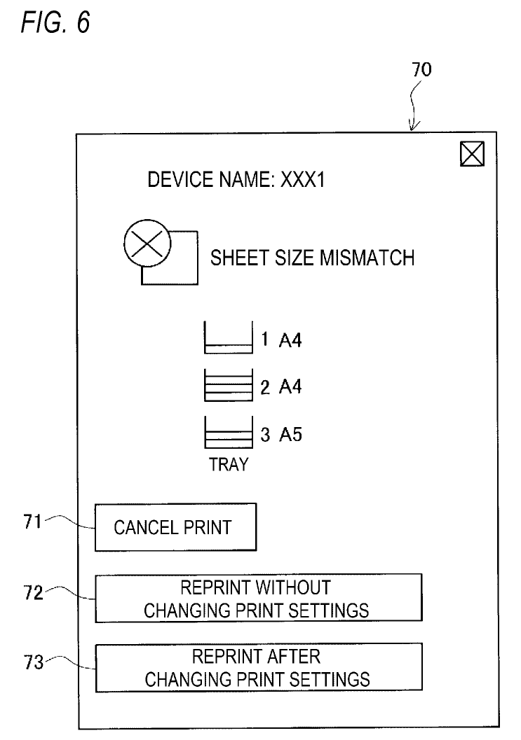

Therefore, in B12, the auxiliary program 42 displays a sheet size mismatch handling screen 70 including a button 71 for receiving print cancellation, a button 72 for receiving an instruction to reprint without changing the print settings, and a button 73 for receiving an instruction to reprint after changing the print settings as shown in FIG. 6. The sheet size mismatch handling screen 70 is an example of a handling screen that can receive re-execution of printing. If the error that has occurred is a setting change required error, the predetermined condition is satisfied, and the auxiliary program 42 displays a handling screen that can receive an instruction to re-execute printing in B12.

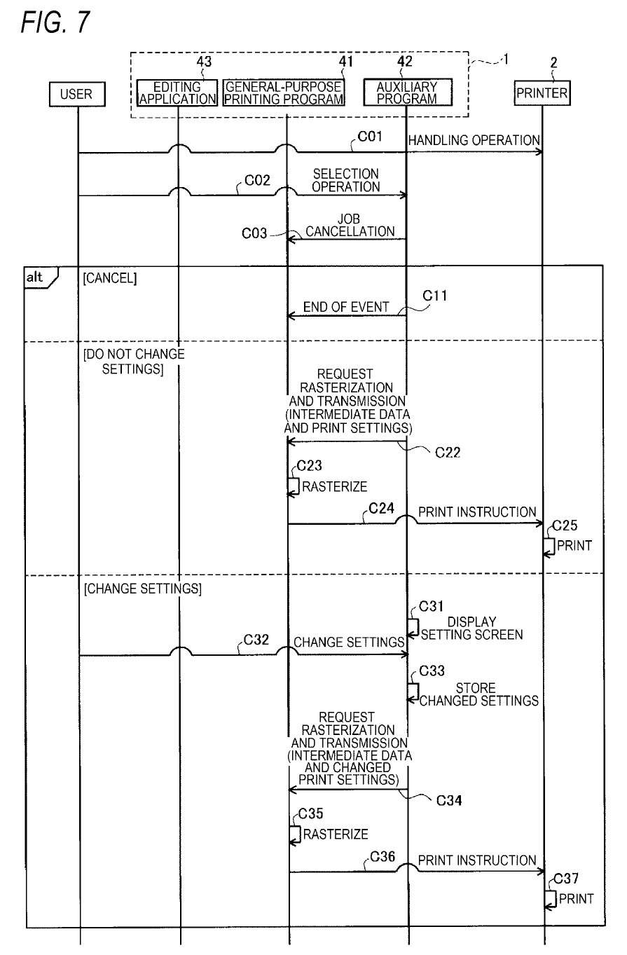

If it is determined that the error is a setting change required error (alt: [setting change required]), the auxiliary program 42 waits for the user to operate the handling screen displayed in B12. In the case of the setting change required error, the auxiliary program 42 displays the handling screen capable of receiving a selection as to whether to change the print settings, thereby increasing the degree of freedom when reprinting is performed. A setting change procedure that is a procedure performed when the setting change required error occurs will be described with reference to the sequence diagram of FIG. 7.

When the auxiliary program 42 receives a selection operation by the user on the handling screen being displayed (C02), the auxiliary program 42 first passes an instruction to cancel the current job to the general-purpose printing program 41 (C03). C02 is an example of the receiving process. The auxiliary program 42 may execute C03 before receiving the operation in C02.

When issuing an instruction to re-execute printing without changing the settings, the user performs a handling operation on the printer 2 before operating the handling screen (C01). For example, when the user operates the button 72 on the sheet size mismatch handling screen 70, the user changes the sheet size set in the printer 2 in advance. For example, in the case of the sheet size mismatch error illustrated in FIG. 6, the user can resolve the mismatch between the print settings and the settings in the printer 2 by storing the sheet of the size designated in the print settings in the tray designated in the print settings and setting the size. When operating the button 71 or the button 73, the user may not perform the handling operation of C01.

When the selection operation by the user received on the handling screen is an operation on the button 71 for receiving print cancellation (alt: [cancel]), the auxiliary program 42 notifies the general-purpose printing program 41 of the end of the event (C11) and ends the process. The operation on the button 71 is an example of the print cancel instruction.

When the received selection by the user is an operation on the button 72 in FIG. 6 and is an instruction to reprint without changing the print settings (alt: [do not change settings]), the auxiliary program 42 performs a procedure for retransmitting the same raster data as the completed job to the printer 2. The instruction to reprint without changing the print settings by the operation on the button 72 is an example of the re-execution instruction, and is an example of the second re-execution instruction. In a case where reprinting is performed without changing the print settings, it is considered that the user performs the handling operation on the printer 2, as described above (C01).

The auxiliary program 42 passes the intermediate data and the print settings stored in A06 of FIG. 2 to the general-purpose printing program 41, and requests rasterization and transmission (C22). The general-purpose printing program 41 performs rasterization to generate raster data (C23), and transmits the raster data to the printer 2 as a new job (C24). The raster data generated by the general-purpose printing program 41 in C23 is the same as the raster data generated in A13 of FIG. 2. The printer 2 executes printing based on the newly received print instruction (C25). The process of C22 by the auxiliary program 42 is an example of the reprint process.

When the received selection by the user is an operation on the button 73 of FIG. 6 and is an instruction to change the print settings and reprint (alt: [change settings]), the auxiliary program 42 causes the user IF 13 to display a setting screen for receiving a change instruction of the print settings (C31), and receives a user operation. The print settings stored in A06 of FIG. 2 is displayed on the setting screen displayed in C31, and a change instruction by the user can be received. The setting screen displayed in C31 is an example of an editing screen. The instruction to reprint after changing the print settings by the operation on the button 73 is an example of the re-execution instruction, and is an example of the first re-execution instruction.

When the print setting is changed by a user operation (C32), the auxiliary program 42 stores the changed print settings by overwriting the print settings stored in A06 of FIG. 2 with the changed print settings (C33). C31 and C32 are an example of the change process. C33 is an example of an overwrite storing process. The print settings after the change instruction is received in C32 are an example of the changed print setting.

The auxiliary program 42 passes the intermediate data and the changed print settings stored in A06 of FIG. 2 to the general-purpose printing program 41, and requests rasterization and transmission (C34). The general-purpose printing program 41 performs rasterization to generate raster data (C35), and transmits the raster data to the printer 2 as a new job (C36). In this case, the raster data generated by the general-purpose printing program 41 in C35 is different from the raster data generated in A13 of FIG. 2. The printer 2 executes printing based on the newly received print instruction (C37). The process of C34 by the auxiliary program 42 is an example of the reprint process.

In the case of an error that may enable printing by changing the print settings, the auxiliary program 42 receives changes to the print settings made by the user. The changed print settings are print settings based on the print settings stored in C33 of FIG. 7, and the printer 2 executes printing in C37 based on the intermediate data stored in A06 of FIG. 2 and changed print settings stored in C33 of FIG. 7. When a change in print settings is received, the auxiliary program 42 transmits an instruction to the printer 2 to reprint using the changed print settings, and therefore, the possibility of succeeding in printing by the printer 2 increases. Furthermore, the auxiliary program 42 stores the changed print settings, so that if an error occurs again, reprinting can be executed based on the changed print settings.

Instead of storing the intermediate data in A06 of FIG. 2, the auxiliary program 42 may acquire the raster data generated by the general-purpose printing program 41 in A13 and store the raster data and the print settings. If the raster data is stored, it is not necessary to perform rasterization again at the time of reprinting. For example, instead of the rasterization instruction of B36 or C22, the auxiliary program 42 may pass the raster data to the general-purpose printing program 41 and instruct the general-purpose printing program 41 to transmit the raster data to the printer 2.

However, in a case where the raster data is stored, the auxiliary program 42 makes the parameters used to generate the raster data unchangeable when the change of the print setting is received in C31. For example, in the case of the sheet size mismatch error illustrated in FIG. 6, the auxiliary program 42 allows a change of the tray but does not allow a change of the sheet size. The auxiliary program 42 may display a setting screen including only items for which changes can be accepted, or may display items for which changes cannot be accepted as unchangeable, or may, when an instruction to change an item for which changes cannot be accepted is received, display a message indicating that the change cannot be accepted and not accept the change.

If the raster data is stored, the raster data can be retransmitted as it is to allow the printer to start reprinting sooner, but the parameters used to generate the raster data cannot be changed. When storing the raster data, the auxiliary program 42 disables a change to the parameters used for generating the raster data, so that it is possible to prevent inappropriate changes to the print settings. On the other hand, if the intermediate data is stored, the change content of the parameters can be reflected in the raster data. Therefore, the degree of freedom in changing the print settings is high.

As described above in detail, when a print instruction is given, the auxiliary program 42 stores the intermediate data and the print settings according to the print instruction. When an error occurs in the printer 2, for example, by receiving an instruction for reprinting from the user, the auxiliary program 42 can cause the printer 2 to perform printing again based on the stored intermediate data and print settings. Therefore, the printer 2 can perform reprinting without requiring the user to issue the print instruction again from the editing application 43.

Each of the embodiments disclosed in the present specification are merely an example, and does not limit the present invention. Therefore, various improvements and modifications can be naturally made to the technique disclosed in the present specification without departing from the gist of the present invention. For example, the device connected to the PC 1 is not limited to the printer 2, and may be any device having a printing function and a communication function, such as a multi function device, a copying machine, or a fax machine. The number of printers 2 connected to the PC 1 may be two or more.

In addition, the respective handling screens illustrated in FIGS. 4 to 6 are merely examples, and the present invention is not limited to the screens shown in these figures. The handling screen only needs to include information indicating the type of error, an example of the handling method, various operation buttons, and the like, and the message wording and button layout are not limited to the example shown in the figure. When an error is to be reported, the auxiliary program 42 may output a warning sound.

Further, in the case of the setting change required error, the auxiliary program 42 of the present embodiment displays the screen for receiving a setting change and receives a change to the print settings by the user, but it is not necessary to accept such changes. The auxiliary program 42 may, for example, display a message instructing a change to the setting in the printer 2, or may simply report an error that requires a change to the print settings and not accept a request to reprint.

Further, for example, although it is described that the error report by the general-purpose printing program 41 is suppressed, the error report may not be suppressed. In other words, A23 in FIG. 2 may be omitted. If the error is reported from both the general-purpose printing program 41 and the auxiliary program 42, the user may become confused. Therefore, it is preferable to suppress report by the general-purpose printing program 41.

Further, for example, when the general-purpose printing program 41 or the OS 21 is configured to end a job in which an error has occurred, the procedure of job cancellation (B32 in FIG. 3, C03 in FIG. 7) may be omitted.

Further, for example, when an error event is output and the type of error is un-continuable error or setting change required error, the auxiliary program 42 can accept the instruction to re-execute printing by a user operation on the user IF 13, but the present invention is not limited thereto. For example, the auxiliary program 42 may be capable of receiving re-execution of printing from the printer 2. Specifically, after transmitting the error notification, the printer 2 may receive an instruction to re-execute printing by a user operation via an operation panel or the like, and when the re-execution instruction is accepted, the printer 2 may transmit the information to the PC 1. In this case, the auxiliary program 42 may be activated in response to the output of the error event, wait for a notification from the printer 2, and then end the process upon a timeout, for example.

Further, the general-purpose printing program 41 may activate the auxiliary program 42 before or after the print screen is displayed, when the normally used printer is changed from another printer to the printer 2 by a user operation. Further, the auxiliary program 42 may acquire the capability information of the printer 2 in response to being activated.

In each embodiment, although only the printing operations have been described in detail as the operations of the auxiliary program 42, the auxiliary program 42 may also have other roles. The program that executes the process of each embodiment is not limited to the auxiliary program 42, but may be any program that receives an instruction from the OS 21 or the general-purpose printing program 41 when printing is performed using the general-purpose printing program 41. For example, a print workflow application (Print workflow) whose specifications have been published by Microsoft may be used.

Further, an execution timing of the auxiliary program 42 is not limited to the example in each embodiments. For example, it may be executed in response to a direct execution instruction from the OS 21, or may be a resident auxiliary program 42. If it is resident, the auxiliary program 42 may receive an execution command and perform the above-described operations.

In any sequence diagram disclosed in each of the embodiments, an execution order of a plurality of processes in any plurality of steps can be freely changed or can be executed in parallel within a range in which no contradiction occurs in a process content.

The processes disclosed in each of the embodiments may be executed by hardware such as a single CPU, a plurality of CPUs, and an ASIC, or a combination thereof. In addition, the processes disclosed in the embodiments can be implemented in various modes such as a recording medium in which a program for executing the processes is recorded, or a method.

When a print instruction is received, the support program disclosed in the present specification stores the print data to be printed and the print setting corresponding to the print instruction. When an error occurs in the printer and a predetermined condition is satisfied, the support program receives reissue of printing. When re-execution of printing is received, the support program causes the printer to perform printing again based on the stored print data and print setting. This makes it possible to perform reprinting on the printer without requiring the user to issue a print instruction with the application program again.

An information processing device incorporating the support program, a computer-readable storage medium storing the support program, a control method for implementing a function of the support program, and a printing system including the support program and the printer are also novel and useful.

The technique disclosed in the present specification implements the technique for reducing time and effort of a user for reprinting when an error occurs in a printer in an information processing device in which an OS-standard general-purpose printing program is incorporated.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a support program executable by a computer of an information processing device and corresponding to a printer connected to the information processing device, the information processing device being mounted with an operating system having a general-purpose printing program,
wherein the support program causes the computer to execute:
when a print instruction that is output from an application program incorporated in the information processing device and that instructs the general-purpose printing program to cause the printer to print an image is received,
a storing process of storing print data indicating the image to be printed by the print instruction and a print setting corresponding to the print instruction in a memory of the information processing device; and
a print process of causing the printer to perform printing according to the print data and the print setting,
wherein the general-purpose printing program is configured to output an error event in response to receiving an error notification from the printer that has received the print data, and
wherein the support program causes the computer to further execute:
in a case where the error event is output from the general-purpose printing program and a predetermined condition is satisfied,
a receiving process of receiving re-execution of the printing; and
in a case where the re-execution is received in the receiving process,
a reprint process of causing the printer to perform the printing based on the print data and the print setting which are stored in the memory.

2. The storage medium according to claim 1,
wherein the computer is caused to, in the case where the error event is output from the general-purpose printing program and the predetermined condition is satisfied, execute, before executing the reprint process, a change process of displaying an editing screen for receiving a change to a print setting based on the print setting stored in the memory, and changing the print setting based on the editing screen, and
wherein in the reprint process, if the print setting is changed in the change process, the printer is caused to perform printing using changed print setting obtained by changing based on the print setting stored in the memory.

3. The storage medium according to claim 2,
wherein the computer is caused to, when the print setting is changed in the change process, execute an overwrite storing process of overwriting the changed print setting onto the print setting stored in the memory.

4. The storage medium according to claim 2,
wherein in the print process, the printer is caused to perform printing based on raster data obtained by rasterizing intermediate data passed from the general-purpose printing program according to the print setting corresponding to the print instruction,
wherein in the storing process, the raster data is stored in the memory as the print data,
wherein in the change process, a parameter used to generate the raster data among the print setting is not allowed to be changed, and
wherein in the reprint process, when the print setting is changed in the change process, the printer is caused to perform printing based on the raster data stored in the memory and the changed print setting.

5. The storage medium according to claim 2,
wherein in the print process, the printer is caused to perform printing based on raster data obtained by rasterizing intermediate data passed from the general-purpose printing program according to the print setting corresponding to the print instruction,
wherein in the storing process, the intermediate data is stored in the memory as the print data, and
wherein in the reprint process, when the print setting is changed in the change process, the printer is caused to perform printing based on the changed print setting and raster data rasterized according to the changed print setting.

6. The storage medium according to claim 1,
wherein in the receiving process, an operation including a print re-execution instruction and a print cancel instruction is received via a user interface of the information processing device, and
wherein the computer is caused to:
when the re-execution instruction is received in the receiving process, execute the reprint process, and
when the cancel instruction is received in the receiving process, end a job based on the print instruction without executing the reprint process.

7. The storage medium according to claim 6,
wherein in the receiving process, via the user interface, an operation including a first re-execution instruction for performing printing by changing a print setting and a second re-execution instruction for performing printing without changing a print setting is received as the re-execution instruction, and
wherein the computer is caused to:
when the first re-execution instruction is received in the receiving process, execute, before executing the reprint process, a change process of displaying an editing screen for receiving a change to a print setting based on the print setting stored in the memory and changing the print setting based on the editing screen, and in the subsequent reprint process, cause the printer to perform printing based on the print data stored in the memory and a changed print setting that is the print setting after the changing; and
when the second re-execution instruction is received in the receiving process, execute the reprint process without executing the change process.

8. The storage medium according to claim 6,
wherein the computer is caused to:
in the case where the error event is output from the general-purpose printing program,
execute an acquisition process of acquiring a type of an error that has occurred in the printer; and
if the type of the error acquired in the acquisition process is a first type of error that allows printing to continue without retransmitting print data after the error is resolved, not execute the receiving process and the reprint process, and
if the type of the error acquired in the acquisition process is a second type of error that does not allow printing to continue after the error is resolved, execute the receiving process when the predetermined condition is satisfied, and execute the reprint process when the re-execution instruction is received in the receiving process.

9. The storage medium according to claim 8,
wherein the computer is caused to:
in the case where the error event is output from the general-purpose printing program,
if the type of the error acquired in the acquisition process is a third type of error among the second type of error, which allows printing if the print setting is changed, in the receiving process, receive as the re-execution instruction via the user interface, an operation including a first re-execution instruction for performing printing by changing a print setting and a second re-execution instruction for performing printing without changing a print setting; and
when the first re-execution instruction is received in the receiving process, execute, before executing the reprint process, a change process of displaying an editing screen for receiving a change to a print setting based on the print setting stored in the memory and changing the print setting based on the editing screen, and in the subsequent reprint process, cause the printer to perform printing based on the print data stored in the memory and a changed print setting that is the print setting after the changing, and
when the second re-execution instruction is received in the receiving process, execute the reprint process without executing the change process.

10. The storage medium according to claim 1,
wherein the computer is caused to execute an error report process of reporting occurrence of an error in the printer in the case where the error event is output from the general-purpose printing program.

11. The storage medium according to claim 10,
wherein the computer is caused to:
in the case where the error event is output from the general-purpose printing program,
execute an acquisition process of acquiring a type of the error that has occurred in the printer, and
wherein in the error report process, an error report screen including the type of the error acquired in the acquisition process and a handling method for handling the type of error is displayed on a user interface of the information processing device.

12. The storage medium according to claim 10,
wherein the computer is caused to, in the case where the error event is output from the general-purpose printing program, execute a setting process of setting the general-purpose printing program to no-error-report, and the general-purpose printing program is configured to, when the error notification is received from the printer, report an error if the no-error-report is not set, and not report an error if the no-error-report is set.
